(19) United States
(12) Patent Application Publication
(10) Pub. No.: US 2008/0194375 A1
(43) Pub. Date: Aug. 14, 2008

(54) Planetary gear mechanism

(75) Inventors: Alexander Voigt, Hormersdorf (DE); Erik Schneider, Chemnitz (DE)

Correspondence Address: COLLARD & ROE, P.C., 1077 NORTHERN BOULEVARD, ROSLYN, NY, 11576, US

(73) Assignee: IAV GmbH Ingenieurgesellschaft Auto und Verkehr

(21) Appl. No.: 12/011,395

(22) Filed: Jan. 25, 2008

(30) Foreign Application Priority Data
Feb. 8, 2007 (DE) 10 2007 007 037.5

(51) Int. Cl. F16H 3/44

(52) U.S. Cl. 475/296; 475/286

(57) ABSTRACT

A planetary gear mechanism that follows or precedes a transmission, and consists of a housing, a sun wheel, at least two planet wheels, a planet arm, and a gear ring. There is a locking device for the housing, the gear ring, and a power take-off, and a locking device for the housing, the planet arm, and the power take-off.

### CROSS REFERENCE TO RELATED APPLICATIONS

Applicants claim priority under 35 U.S.C. §119 of German Application No. 10 2007 007 037.5 filed Feb. 8, 2007.

### BACKGROUND OF THE INVENTION

1. Field of the Invention

The invention relates to a planetary gear mechanism that follows or precedes a transmission.

2. The Prior Art

A mechanical, additional planetary gear mechanism having a large translation jump is described in German Patent No. DE 20 59 351 A1. The planetary gear mechanism is assembled to a mechanically switchable transmission having a precise gradation. The planetary gear mechanism consists of a simple planetary gear mechanism whose input element is a sun wheel and whose power take-off element is a planet carrier.

A switching sleeve is mounted with an outer gearing so as to be displaceable in the gearing of the outer wheel, and with an inner gearing so as to be displaceable on a centering piece. The switching sleeve, in an outer position, connects the outer wheel with the first gearing that is rigidly connected with the planet carrier, and in the second outer position, with the second gearing that is rigidly connected with the housing of the additional transmission.

A transmission assembly for vehicles, particularly motor vehicles, is known from German Patent No. DE 33 30 303 C2, having a planetary gear mechanism held in a housing, configured as an axle translation and reversing gear mechanism. The planetary gear mechanism has a sun wheel that can be connected with a drive, a ring wheel, and a planet carrier that carries planet wheels. To produce a drive connection, in a first direction of rotation, the planet carrier can be connected with a power take-off wheel that follows the planetary gear mechanism, and the ring wheel can be connected with the fixed housing, and in a second direction of rotation, the ring wheel can be connected with the power take-off wheel and the planet carrier can be connected with the housing.

A pushing cuff is held on the power take-off wheel so as to rotate with it, but is axially displaceable. The cuff can optionally be coupled, by way of a dual-action first synchronization device, with one of two components that lie axially next to one another, one of which is connected with the planet carrier and the other of which is connected with the ring wheel.

The pushing cuff carries a switching wheel held so as to rotate, but axially not displaceable, which stands in constant engagement with a gearing on a component connected with the ring wheel, and can be connected with a component held on the housing by way of a second synchronization device, in the case of an axial displacement.

An epicyclic planetary gear mechanism is described in DE 920 532 B. This mechanism follows a turbocharger, and has spur wheels disposed in a plane in a non-displaceable manner, of which the inner sun wheel is constantly connected with the drive shaft, while planet carrier and outer sun wheel can be individually or jointly connected with the power take-off shaft, or locked in place by means of friction brakes, in order to achieve a step-down forward gear, a step-down reverse gear, or a direct forward gear.

The planet carrier and the outer sun wheel can be connected with the power take-off shaft by way of a switching cuff or the like, with shape fit, but with one another by way of a friction clutch that can be switched arbitrarily, with force fit.

A reversing circuit for use in transmission modules for a direction reversal between an input and an output is described in DE 101 46 836 A1. A first element of a planet wheel set is coupled with a drive so as to rotate with it. A second and third element of the planet wheel set are each connected with a power take-off, by way of a freewheel. The two freewheels are configured to lock opposite directions of rotation of the power take-off. The reversing circuit comprises a relative speed of rotation production device, assigned to the second element and the third element, for example in a configuration as brake units, to produce a relative speed of rotation between the second element and the third element and the power take-off.

### SUMMARY OF THE INVENTION

It is therefore an object of the invention to provide a planetary gear mechanism having a direction reversal and a possibility of switching between an upper and a lower gear group.

This object is achieved according to the invention by a planetary gear mechanism that follows or precedes a transmission, and which comprises a housing, a sun wheel, at least two planet wheels, a planet arm and a gear ring. There is a first locking device for the housing, the gear ring, and a power take-off, as well as a second locking device for the housing, the planet arm, and the power take-off.

For a rotation of the power take-off in the direction of rotation of the drive, in an upper gear group, the planet arm can be connected with the power take-off by way of the second locking device, and the gear ring can be connected with the power take-off by way of the first locking device. For a rotation of the power take-off in the direction of rotation of the drive, in a lower gear group, the planet arm can be connected with the power take-off by way of the second locking device, and the gear ring can be connected with housing by way of the first locking device. For a rotation of the power take-off opposite the direction of rotation of the drive, in the lower gear group, the planet arm can be connected with the housing by way of the second locking device, and the gear ring can be connected with the power take-off by way of the first locking device. For no rotation of the drive and no rotation of the power take-off, the planet arm can be connected with the housing and the power take-off by way of the second locking device, and the gear ring can be connected with the housing and the power take-off by way of the first locking device.

The planetary gear mechanism according to the invention allows a direction reversal, i.e. forward and reverse travel, and, a choice between an upper gear group, i.e. step-up translation, and a lower gear group, i.e. step-down translation.

Furthermore, the planetary gear mechanism makes it possible for both the drive and the power take-off to be fixed to the housing of the planetary gear mechanism so as not to turn, so that this results in the vehicle coming to a stop.

The planetary gear mechanism according to the invention allows travel in a direction that corresponds to the direction of rotation of the drive, for example forward travel, in all gear levels of the transmission in the upper gear group, and in all gear levels of the transmission in the lower gear group. Furthermore, the planetary gear mechanism according to the invention allows travel in the opposite direction, for example reverse travel, in all gear levels of the transmission in the lower gear group.

If the transmission has six gear levels, for example, then it is possible to implement six forward gears in the upper gear group, six forward gears in the lower gear group, and six reverse gears in the lower gear group, using the planetary gear mechanism according to the invention.

Furthermore, the planetary gear mechanism according to the invention also allows forward travel in the lower gear group and reverse travel both in the upper and the lower gear group, if a direction reversal of the direction of rotation of the drive takes place between the transmission and the planetary gear mechanism.

In an advantageous embodiment of the invention, the locking device is a switching cuff. A switch between the two gear groups, or in the case of a direction reversal, can only take place when the vehicle is at a stop. If the drive is braked by means of a so-called engine brake while the vehicle is traveling, braking, i.e., a reduction in the speed of rotation, of the drive takes place, depending on the inertia and bearing moment, as well as the sealing moment.

In an advantageous embodiment of the invention, the locking device is a claw clutch. A switch between the two gear groups, or in the case of a direction reversal, can take place during travel, but without transfer of force. If the drive is braked by a so-called engine brake while the vehicle is traveling, braking, i.e. a reduction in the speed of rotation, of the drive takes place, depending on the inertia and bearing moment, as well as the sealing moment.

In an advantageous embodiment of the invention, two freewheels are integrated into the connection between the planetary gear mechanism and the power take-off, in the planetary gear mechanism according to the invention. One freewheel is disposed between the planet arm and the power take-off, and the other freewheel is disposed between the gear ring and the power take-off. Drive takes place by way of the sun wheel, which is rigidly connected with the drive. The freewheels have opposite locking directions, so that the locking direction of the one freewheel corresponds to the freewheeling direction of the other freewheel. The locking direction of the freewheel that is disposed between the planet arm and the power take-off corresponds to the direction of rotation of the sun wheel and therefore of the drive.

For a reversal of the direction of rotation, the planet arm, also called the planet carrier, is connected with the housing so as not to rotate, by way of a locking device, for example a brake rigidly connected with the housing, or a switchable freewheel. For a switch into the lower gear group, the gear ring is connected with the housing so as not to rotate, for example by means of a brake rigidly connected with the housing, or a switchable freewheel.

In the normal travel range, i.e. in the upper gear group, the planetary gear mechanism turns at the speed of rotation of the driven sun wheel, because of the opposite-direction arrangement of the freewheels, i.e. the freewheeling direction of the one freewheel corresponds to the locking direction of the other freewheel, without any degree of freedom. In this connection, no differences in speed occur between planet arm and power take-off or between gear ring and power take-off, so that in travel operation, only very slight losses of the drive power occur.

To switch into the lower gear group, i.e. step-down translation, the gear ring is locked against the housing by the locking device so as not to rotate, for example by means of a brake rigidly connected with the housing, or a switchable freewheel, without interruption in the tractive force from drive to power take-off.

In a switchable freewheel, the locking effect can be cancelled out by switching, i.e., in one of the two switching positions, both directions of rotation of the freewheel are freewheeling directions, and in the other switching position, one direction of rotation of the freewheel is the locking direction, and the other direction of rotation is the freewheeling direction.

To switch into the other direction of rotation, for example reverse travel, starting from normal travel, i.e., forward travel, the planet arm is locked against the housing by the locking device, so as not to rotate, for example by a brake rigidly connected with the housing, or a switchable freewheel. The direction of rotation of the power take-off moment is changed without any interruption in the tractive force.

The planetary gear mechanism offers an additional functionality in all travel ranges, i.e. forward, reverse, upper and lower gear group, by means of the freewheeling function, in order to be able to present energy savings measures by the elimination of an engine brake. Switching between the individual travel ranges can take place during travel.

The planetary gear mechanism according to the invention consists of very few components, so that a low weight and price-advantageous production are possible.

It is advantageous that locking of the planet arm and the gear ring with regard to the housing can take place by means of brakes, for example multi-disk brakes or disk brakes.

In the case of shape-fit locking devices, braking of the vehicle brought about by the engine braking moment takes place, in coasting operation, beyond the braking effect of air resistance, incline resistance, and rolling resistance.

In the case of locking devices in the configuration of freewheels, this braking effect does not exist, since the overtaking effect in the freewheeling direction does not result in any transfer of moment. Thus, a reduction in the speed of rotation of the drive is possible without any switching or clutching process, while maintaining the speed of rotation of the power take-off.

### BRIEF DESCRIPTION OF THE DRAWINGS

Other objects and features of the present invention will become apparent from the following detailed description considered in connection with the accompanying drawings. It is to be understood, however, that the drawings are designed as an illustration only and not as a definition of the limits of the invention.

In the drawings, wherein similar reference characters denote similar elements throughout the several views:

FIGS. 1a-d show schematic representations of a first embodiment of a planetary gear mechanism according to the invention;

FIGS. 2a-d show schematic representations of a second embodiment of a planetary gear mechanism according to the invention;

FIG. 3 shows a schematic representation of a third embodiment of a planetary gear mechanism according to the invention;

FIG. 4 shows a planetary gear mechanism according to the invention, partly in section; and

FIG. 5 shows a planetary gear mechanism according to the invention, partly in section.

### DETAILED DESCRIPTION OF THE EMBODIMENTS

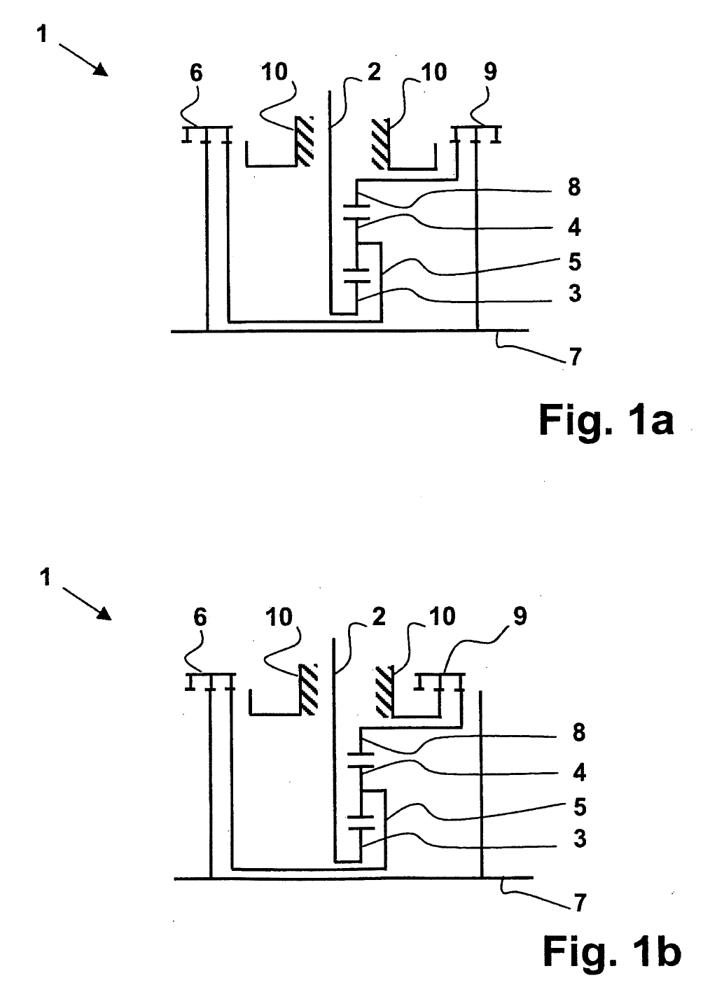

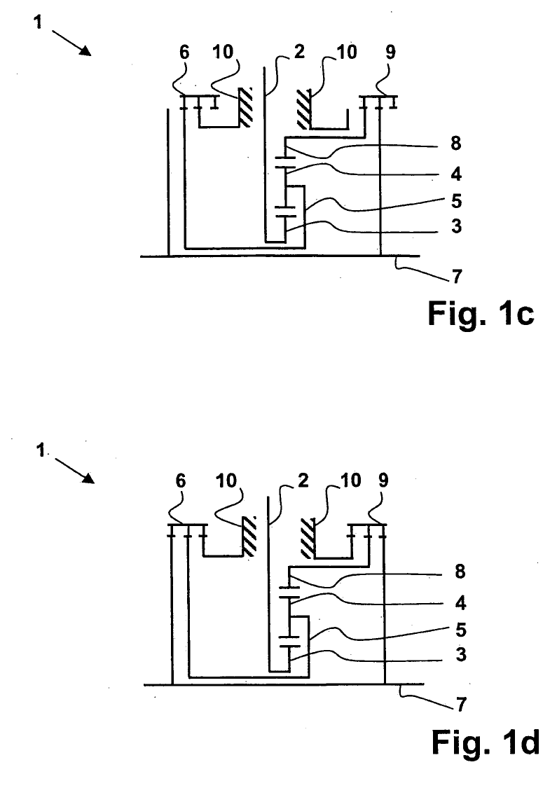

Referring now in detail to the drawings and, in particular, FIG. 1a shows a schematic representation of a first embodiment of a planetary gear mechanism 1 according to the invention. Planetary gear mechanism 1 follows a transmission, not shown, for example a standard transmission or an automatic transmission, in such a manner that a power take-off of the transmission is a drive 2 of the planetary gear mechanism 1. A sun wheel 3 is rigidly connected with drive 2. If sun wheel 3 is driven in one direction of rotation by means of drive 2, planet wheels 4 roll on sun wheel 3 in a direction of rotation that is opposite the direction of rotation of sun wheel 3. Planet wheels 4 attempt to drive a planet arm 5, by way of which they are connected with one another, in the direction of rotation of sun wheel 3.

Planetary gear mechanism 1 comprises a locking device 6, for example in the configuration of a switching cuff or claw clutch, which connects planet arm 5 with power take-off 7 in such a manner that a torque is transferred from planet arm 5 to power take-off 7, so that power take-off 7 turns in the direction of rotation of sun wheel 3. Planet arm 5 works against the inertia of a drive moment of the vehicle wheels situated at the end of power take-off 7, and thus of the vehicle. Since planet wheels 4 perform a transfer of force to a gear ring 8, directed counter to the direction of rotation of sun wheel 3, by way of the feedback from planet arm 5, to overcome this counter-moment, gear ring 8 is driven in the direction of rotation that is opposite the direction of rotation of sun wheel 3, by planet wheels 4.

The direction of rotation that is opposite the direction of rotation of sun wheel 3 is now prevented by a locking device 9, for example in the configuration of a switching cuff or a claw clutch, which connects gear ring 8 with power take-off 7, and no relative speed of rotation is permitted. A relative movement between planet arm 5 and gear ring 8 is prevented by means of this bracing within power take-off 7, so that the direction of rotation of planet arm 5, the direction of rotation of the gear ring 8, and the direction of rotation of power take-off 7 correspond to the direction of rotation of sun wheel 3. The speed of rotation of planet arm 5 and the speed of rotation of gear ring 8 correspond to the speed of rotation of sun wheel 3. Thus, the speed of rotation of power take-off 7 corresponds to the speed of rotation of drive 2. From this arrangement, a rotation of power take-off 7 in the direction of rotation of sun wheel 3 and of drive 2, for example forward, is made possible in the upper gear group.

FIG. 1b shows the state of the planetary gear mechanism in which a switch is made from fast forward travel, i.e. the upper gear group, into a slow forward gear, i.e. the lower gear group, whereby the switch can take place only when the vehicle is standing or by activating a clutch, in the case of a switching cuff. Gear ring 8 is locked against housing 10 of the planetary gear mechanism 1, by way of locking device 9, in such a manner that gear ring 8 is connected with housing 10 so as not to rotate. Planet arm 5 is connected with power take-off 7 by way of locking device 6.

Because of the inertia of the vehicle, power take-off 7 is driven by planet arm 5, which now rotates at the same speed of rotation as drive 2, at a lower speed of rotation of power take-off 7, for example 1+stationary gear ratio. Stationary gear ratio is the ratio of the number of teeth of gear ring 8, with a negative sign, to the number of teeth of sun wheel 3.

FIG. 1c shows the state of planetary gear mechanism 1 in which planet arm 5 is connected with housing 10, so as not to rotate, by means of locking device 6, in the case of a switch to reverse travel. Gear ring 8 is connected with power take-off 7 by way of locking device 9. The speed of rotation of the power take-off 7 is less, in comparison with the speed of rotation of the drive 2, so that a direction of rotation, for example reverse, in the lower gear group, is made possible by means of this arrangement. The ratio corresponds to the stationary gear ratio.

FIG. 1d shows the state of planetary gear mechanism 1 in which planet arm 5 is locked by locking device 6, in the case of a switch to the “park” mode, in such a manner that planet arm 5 is connected with housing 10 and power take-off 7, so as not to rotate. Gear ring 8 is locked by locking device 9, in such a manner that gear ring 8 is connected with housing 10 and power take-off 7 so as not to rotate. In this state, a rotation of neither drive 2 nor of power take-off 7 is possible.

In order to activate the park mode, the claws that are already in engagement with power take-off 7 are supported by means of an inside gearing of the switching cuff and an outside gearing of housing 10, and a rotational movement of power take-off 7 is prevented.

If drive 2 is braked by a so-called engine brake while a vehicle is traveling, braking, i.e. a reduction in the speed of rotation of power take-off 7, occurs, depending on the inertia and bearing moment, as well as the sealing moment.

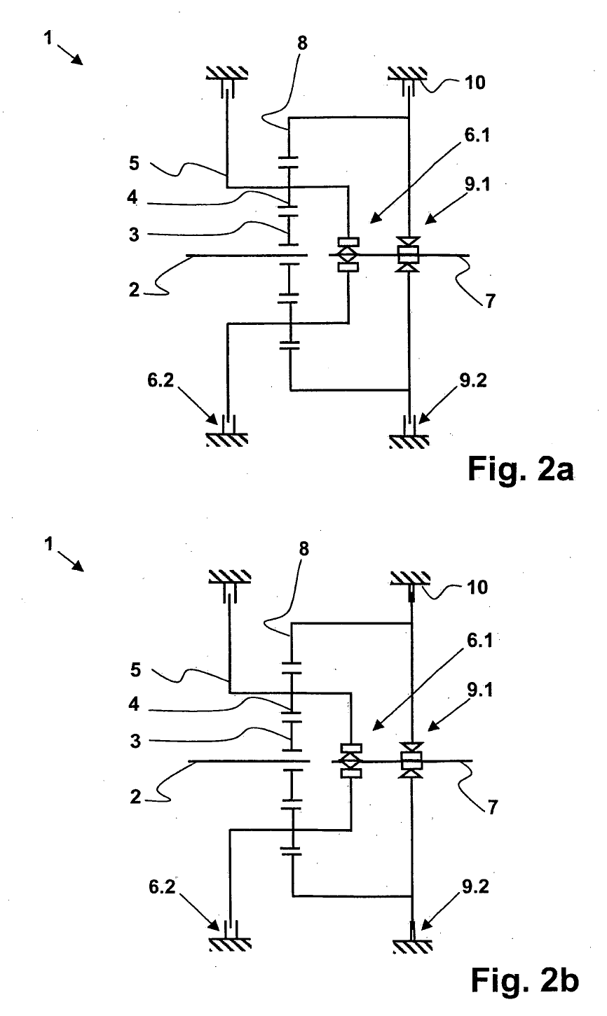

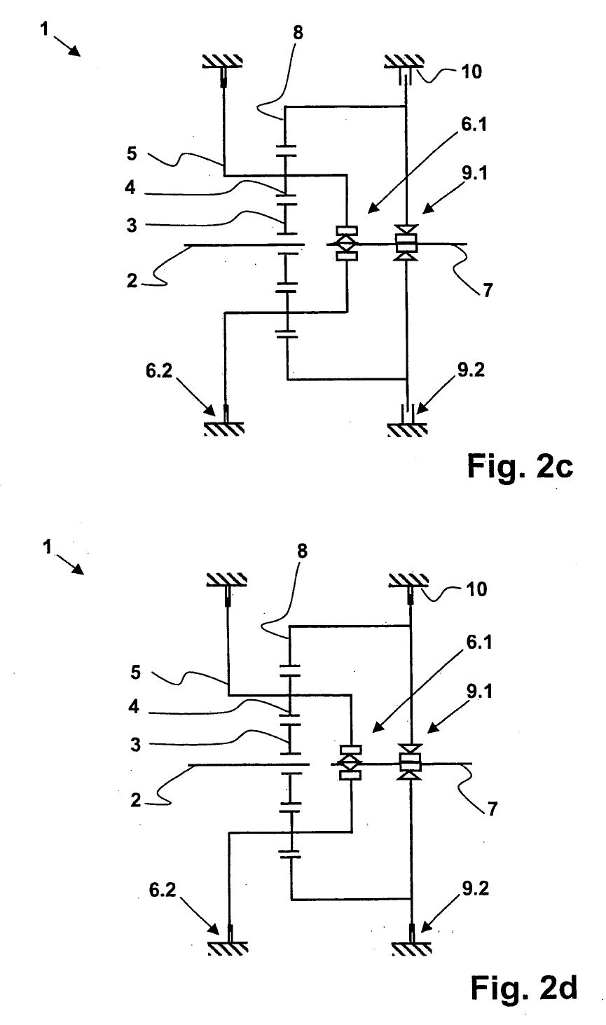

FIG. 2a shows a schematic representation of a second embodiment of a planetary gear mechanism 1 according to the invention. Planetary gear mechanism 1 follows a transmission, not shown, for example a standard transmission or an automatic transmission, in such a manner that a power take-off of the transmission is a drive 2 of planetary gear mechanism 1. A sun wheel 3 is rigidly connected with drive 2. If sun wheel 3 is driven in one direction of rotation by means of drive 2, planet wheels 4 roll on sun wheel 3 in a direction of rotation that is opposite the direction of rotation of sun wheel 3. Planet wheels 4 attempt to drive a planet arm 5, by way of which they are connected with one another, in the direction of rotation of sun wheel 3. In this way, planet arm 5 works against the inertia of a drive moment of the wheels situated at the end of power take-off 7, and thus of the vehicle, by means of a locking direction in the direction of rotation of sun wheel 3 of a locking device 6.1 in the configuration of a freewheel, which is disposed between planet arm 5 and a power take-off 7.

Since planet wheels 4 perform a transfer of force to a gear ring 8, directed counter to the direction of rotation of the sun wheel 3, by way of the feedback from planet arm 5, to overcome this counter-moment, gear ring 8 is driven in the direction of rotation that is opposite the direction of rotation of sun wheel 3, by planet wheels 4.

The direction of rotation that is opposite the direction of rotation of sun wheel 3 is now prevented by a locking device 9.1 in the configuration of a freewheel disposed between gear ring 8 and power take-off 7, in that here, the freewheel locks in a locking direction opposite the direction of rotation of sun wheel 3, and does not permit any relative speed of rotation. A relative movement between planet arm 5 and gear ring 8 is prevented by means of this bracing, resulting from the locking directions of the freewheels within power take-off 7, so that the direction of rotation of planet arm 5, the direction of rotation of gear ring 8, and the direction of rotation of power take-off 7 correspond to the direction of rotation of sun wheel 3. The speed of rotation of planet arm 5 and the speed of rotation of gear ring 8 correspond to the speed of rotation of sun wheel 3. Thus, the speed of rotation of power take-off 7 corresponds to the speed of rotation of drive 2. By means of this arrangement, a rotation of power take-off 7 in the direction of rotation of sun wheel 3 and of drive 2, for example forward, is made possible in the upper gear group.

If drive 2 is braked by a so-called engine brake while a vehicle is traveling, freewheeling of power take-off 7 occurs, depending on the inertia and bearing moment, as well as the sealing moment, since the speed of rotation of power take-off 7 is greater in comparison with the speed of rotation of planet arm 5 and of gear ring 8, and so-called freewheeling of the freewheel occurs. Thus, an engine, not shown, can be throttled, and the vehicle can roll freely, without having to perform any gear change in the transmission or having to clutch out.

FIG. 2b shows the state of the planetary gear mechanism 1 in which a switch is made from fast forward travel, i.e. the upper gear group, into a slow forward gear, i.e. the lower gear group. Gear ring 8 is locked by means of a locking device 9.2, for example in the configuration of a multi-disk brake or disk brake, which is rigidly connected with a housing 10 of planetary gear mechanism 1, in such a manner that gear ring 8 is connected with housing 10 so as not to rotate.

Because of the inertia of the vehicle, power take-off 7 is driven in a freewheeling direction, in the direction of rotation of the sun wheel 3 of freewheel between gear ring 8 and power take-off 7, and by means of planet arm 5, which now rotates at the same speed of rotation as drive 2, at a lower speed of rotation of power take-off 7, for example 1+stationary gear ratio.

By means of rapid braking of gear ring 8 by locking device 9.2, short-term freewheeling of the freewheel between planet arm 5 and power take-off 7 can occur, depending on the travel situation, since power take-off 7 then still rotates faster under planet arm 5 for several rotations, because of the inertia of the vehicle. Once an equal speed of rotation between power take-off 7 and planet arm 5 has been reached, the freewheel engages in the locking direction again, and drives power take-off 7 and the vehicle disposed behind it in the lower gear group.

FIG. 2c shows the state of the planetary gear mechanism 1 in which planet arm 5 is connected with housing 10, so as not to rotate, by means of a locking device 6.2 that is rigidly connected with housing 10 of planetary gear mechanism 1, in the case of a switch to reverse travel. Power take-off 7 turns away under planet arm 5, in the freewheeling direction of the freewheel, since power take-off 7 is driven by gear ring 8 that now rotates in the locking direction of the freewheel, opposite the direction of rotation of sun wheel 3. The speed of rotation of power take-off 7 is less, in comparison with the speed of rotation of drive 2, so that a direction of rotation, for example reverse, in the lower gear group, is made possible by means of this arrangement.

FIG. 2d shows the state of planetary gear mechanism 1 in which planet arm 5 is locked by locking device 6.2, in the case of a switch to the “park” mode, in such a manner that planet arm 5 is connected with housing 10, so as not to rotate. Gear ring 8 is locked by locking device 9.2, in such a manner that gear ring 8 is connected with housing 10 so as not to rotate. Rotation of power take-off 7 is inhibited by means of the freewheeling direction opposite to the direction of rotation of sun wheel 3 of the freewheel, and by the freewheeling direction in the direction of rotation of sun wheel 3 of the freewheel. Locking device 6.2, 9.2 can be structured as a friction brake, for example, and is activated in the locking direction. Together with the freewheels on power take-off 7, these bring about prevention of the rotational movement of power take-off 7 in one direction, in each instance.

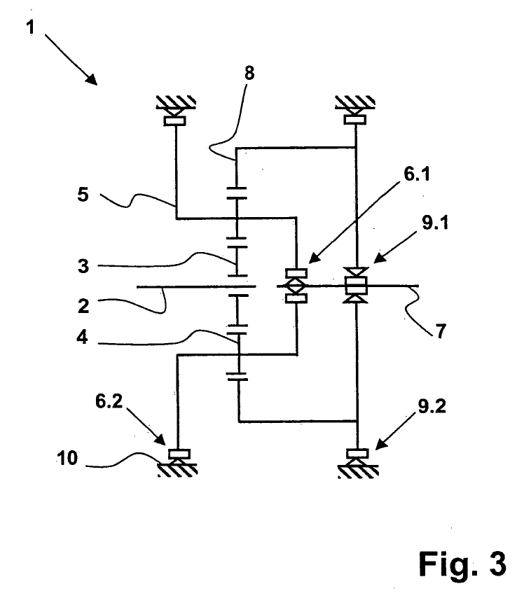

FIG. 3 shows a schematic representation of a third embodiment of a planetary gear mechanism 1 according to the invention. Planetary gear mechanism 1 follows a transmission, not shown, for example a standard transmission or an automatic transmission, in such a manner that a power take-off of the transmission is a drive 2 of planetary gear mechanism 1. A sun wheel 3 is rigidly connected with drive 2. If sun wheel 3 is driven in one direction of rotation by means of drive 2, planet wheels 4 roll on sun wheel 3 in a direction of rotation that is opposite the direction of rotation of sun wheel 3. Planet wheels 4 attempt to drive a planet arm 5, by way of which they are connected with one another, in the direction of rotation of sun wheel 3. In this way, planet arm 5 works against the inertia of a drive moment of the wheels situated at the end of power take-off 7, and thus of the vehicle, by means of a locking direction in the direction of rotation of sun wheel 3 of a locking device 6.1 in the configuration of a freewheel, which is disposed between planet arm 5 and a power take-off 7.

Since planet wheels 4 perform a transfer of force to a gear ring 8, directed counter to the direction of rotation of sun wheel 3, by way of the feedback from planet arm 5, to overcome this counter-moment, gear ring 8 is driven in the direction of rotation that is opposite the direction of rotation of sun wheel 3, by planet wheels 4.

The direction of rotation that is opposite the direction of rotation of sun wheel 3 is now prevented by a locking device 9.1 in the configuration of a freewheel that is disposed between gear ring 8 and power take-off 7. The freewheel locks in a locking direction counter to the direction of rotation of the sun wheel 3, and does not permit any relative speed of rotation. A relative movement between planet arm 5 and gear ring 8 is prevented by this bracing resulting from the locking directions of the freewheels within the power take-off 7, so that the direction of rotation of the planet arm 5, the direction of rotation of the gear ring 8, and the direction of rotation of the power take-off 7 correspond to the direction of rotation of the sun wheel 3. The torque is transferred from the planet arm 5 to the power take-off 7, by way of the freewheel. The speed of rotation of planet arm 5 and the speed of rotation of gear ring 8 correspond to the speed of rotation of sun wheel 3. Thus, the speed of rotation of power take-off 7 corresponds to the speed of rotation of drive 2. By means of this arrangement, a rotation of power take-off 7 in the direction of rotation of sun wheel 3 and of drive 2, for example forward, is made possible in the upper gear group.

If drive 2 is braked by a so-called engine brake while a vehicle is traveling, freewheeling of the power take-off 7 occurs, depending on the inertia and bearing moment, as well as the sealing moment, since the speed of rotation of power take-off 7 is greater in comparison with the speed of rotation of planet arm 5 and of gear ring 8, and so-called freewheeling of the freewheel occurs. Thus, an engine, not shown, can be throttled, and the vehicle can roll freely, without having to perform any gear change in the transmission or having to clutch out.

If a switch is made from fast forward travel, i.e. the upper gear group, into a slow forward gear, i.e. the lower gear group, gear ring 8 is locked by a locking device 9.2 in the configuration of a switchable freewheel, whose locking direction is the direction of rotation of sun wheel 3 that is rigidly connected with a housing 10 of planetary gear mechanism 1, in such a manner that gear ring 8 is connected with housing 10 so as not to rotate.

Because of the inertia of the vehicle, power take-off 7 is driven in a freewheeling direction, in the direction of rotation of sun wheel 3 of the freewheel between gear ring 8 and power take-off 7, and by means of planet arm 5, which now rotates at the same speed of rotation as drive 2, at a lower speed of rotation of power take-off 7, for example 1+stationary gear ratio.

Due to the rapid braking of gear ring 8 by the switchable freewheel, short-term freewheeling of the freewheel between planet arm 5 and power take-off 7 can occur, depending on the travel situation, since power take-off 7 then still rotates faster under planet arm 5 for several rotations, because of the inertia of the vehicle. Once an equal speed of rotation between power take-off 7 and planet arm 5 has been reached, the freewheel engages in the locking direction again, and drives power take-off 7 and the vehicle disposed behind it in the lower gear group.

If planet arm 5 is connected with housing 10, so as not to rotate, by means of a locking device 6.2 in the configuration of a switchable freewheel, whose locking direction is in the direction of rotation of sun wheel 3 that is rigidly connected with the housing 10 of the planetary gear mechanism 1, in the case of a switch to reverse travel, then power take-off 7 turns away under planet arm 5, in the freewheeling direction of the freewheel. This is because power take-off 7 is driven by gear ring 8 that now rotates in the locking direction of the freewheel, opposite the direction of rotation of the sun wheel 3. The speed of rotation of power take-off 7 is less, in comparison with the speed of rotation of drive 2, so that a direction of rotation, for example reverse, in the lower gear group, is made possible by means of this arrangement. The speed of rotation ratio now corresponds to the stationary gear ratio.

If planet arm 5 is locked in such a manner by means of the switchable freewheel, in the case of a switch to the “park” mode, then planet arm 5 is connected with housing 10, so as not to rotate. Gear ring 8 is locked by the switchable freewheel, in such a manner that gear ring 8 is connected with housing 10 so as not to rotate. Rotation of power take-off 7 is inhibited by means of the freewheeling direction opposite to the direction of rotation of sun wheel 3 of the freewheel, and by the freewheeling direction in the direction of rotation of sun wheel 3 of the freewheel. Locking device 6.2, 9.2 can be structured as a switchable freewheel, for example, and is activated in the locking direction. Together with the freewheels on power take-off 7, these bring about prevention of the rotational movement of power take-off 7 in one direction, in each instance.

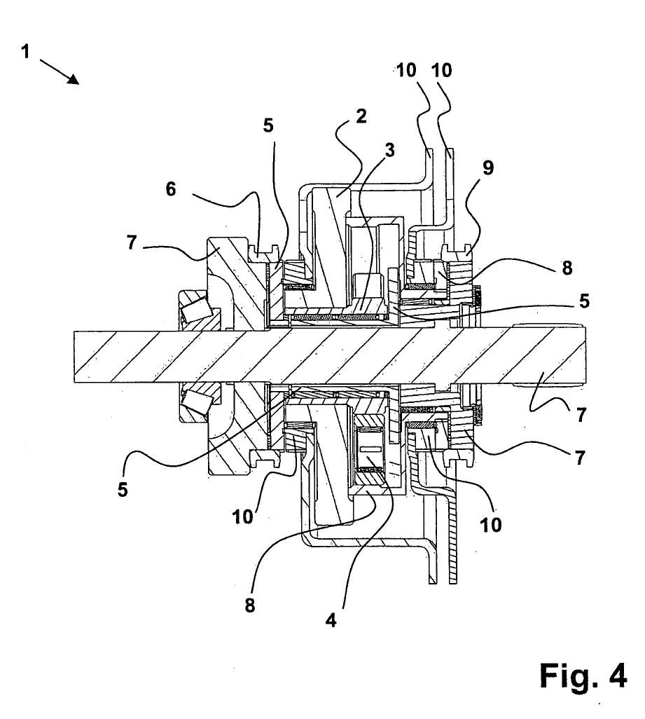

FIG. 4 shows a planetary gear mechanism 1 according to the invention partly in section. In this embodiment, locking devices 6, 9 are switching cuffs.

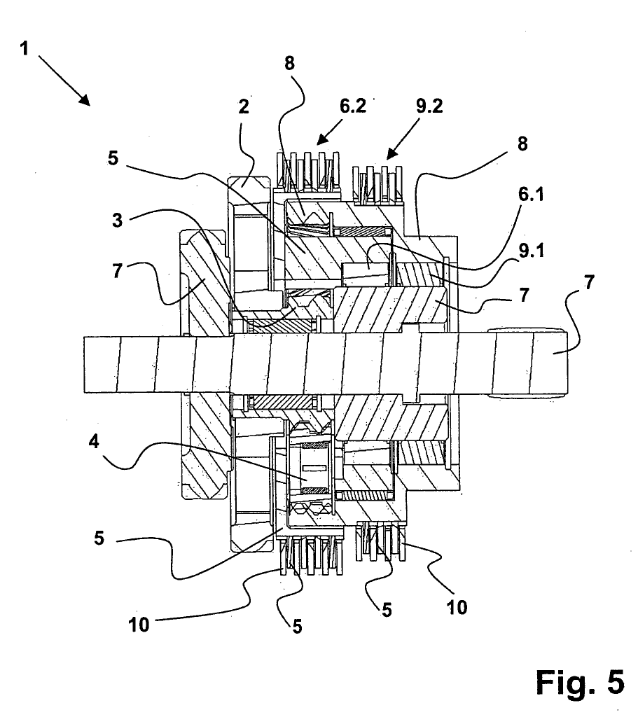

FIG. 5 shows a planetary gear mechanism 1 according to the invention partly in section. In this embodiment, locking devices 6.1, 9.1 are freewheels, and locking devices 6.2, 9.2 are multi-disk brakes.

Accordingly, while only a few embodiments of the present invention have been shown and described, it is obvious that many changes and modifications may be made thereunto without departing from the spirit and scope of the invention.

### Reference Symbol List

1 planetary gear mechanism
2 drive
3 sun wheel
4 planet wheel
5 planet arm
6 locking device
6.1 locking device
6.2 locking device
7 power take-off
8 gear ring
9 locking device
9.1 locking device
9.2 locking device
10 housing

What is claimed is:

1. A planetary gear mechanism that follows or precedes a transmission, comprising:
a housing;
a sun wheel connected to a drive;
at least two planet wheels;
a planet arm connected to the planet wheels;
a gear ring;
a first locking device for the housing, the gear ring, and a power take-off; and
a second locking device for the housing, the planet arm, and the power take-off, wherein
for a rotation of the power take-off in a direction of rotation of the drive, in an upper gear group, the planet arm is connected with the power take-off by way of second locking device, and the gear ring is connected with the power take-off by way of the first locking device, and for a rotation of the power take-off in the direction of rotation of the drive in a lower gear group, the planet arm is connected with the power take-off by way of the second locking device, and the gear ring can be connected with housing by way of the first locking device, and
for a rotation of the power take-off opposite the direction of rotation of the drive, in the lower gear group, the planet arm is connected with the housing by way of the second locking device, and the gear ring is connected with the power take-off by way of the first locking device, and
for no rotation of the drive and no rotation of the power take-off, the planet arm is connected with the housing and the power take-off by way of the second locking device, and the gear ring is connected with the housing and the power take-off by way of the first locking device.

2. The planetary gear mechanism according to claim 1, wherein the second locking device is a switching cuff.

3. The planetary gear mechanism according to claim 1, wherein the second locking device is a claw clutch.

4. The planetary gear mechanism according to claim 1, wherein the first locking device is a switching cuff.

5. The planetary gear mechanism according to claim 1, wherein the first locking device is a claw clutch.

6. The planetary gear mechanism according to claim 1, wherein the first locking device comprises a first locking element for the gear ring and the housing and a second locking element for the gear ring and the power take-off, and wherein the first locking device is a switchable freewheel and a locking direction of the switchable freewheel is the direction of rotation of the drive.

7. A planetary gear mechanism according to claim 1, wherein the second locking device comprises a first locking element for the planet arm and the housing and a second locking element for the planet arm and the power take-off, wherein the second locking device is a switchable freewheel, and a locking direction of the switchable freewheel is the direction of rotation of the drive.
